(19) United States
(12) Patent Application Publication
(10) Pub. No.: US 2020/0409182 A1
(43) Pub. Date: Dec. 31, 2020

(54) OPTICAL ELEMENT AND SPECTACLES

(71) Applicants: Yuuya ENDOH, Kanagawa (JP); Tetsuro Tanigawa, Kanagawa (JP); Noboru Sasa, Kanagawa (JP); Keiichiroh Yutani, Kanagawa (JP); Tohru Hasegawa, Kanagawa (JP); Naoki Ura, Kanagawa (JP)

(72) Inventors: Yuuya ENDOH, Kanagawa (JP); Tetsuro Tanigawa, Kanagawa (JP); Noboru Sasa, Kanagawa (JP); Keiichiroh Yutani, Kanagawa (JP); Tohru Hasegawa, Kanagawa (JP); Naoki Ura, Kanagawa (JP)

(21) Appl. No.: 16/913,690

(22) Filed: Jun. 26, 2020

(30) Foreign Application Priority Data
Jun. 28, 2019 (JP) 2019-121649
Jun. 24, 2020 (JP) 2020-108764

(51) Int. Cl. G02C 7/10; G02F 1/15

(52) U.S. Cl. CPC G02C 7/102; G02C 11/10; G02F 1/15

(57) ABSTRACT

An optical element using an electrochromic material capable of switching between a transparent state and a coloring state, includes a spectrum assisting visual functions or visual perception ability, the spectrum being used for visual recognition of the optical element in the coloring state.

### CROSS-REFERENCE TO RELATED APPLICATIONS

This patent application is based on and claims priority pursuant to 35 U.S.C. § 119(a) to Japanese Patent Application Nos. 2019-121649, filed on Jun. 28, 2019, and 2020-108764, filed on Jun. 24, 2020, in the Japan Patent Office, the entire disclosure of which is hereby incorporated by reference herein.

### BACKGROUND

### Technical Field

The present invention relates to an optical element and spectacles.

### Discussion of the Background Art

An optical element having a spectrum which assists a visual function or visual perception ability is known.

For example, the known color discrimination assist device includes an optical device capable of selectively controlling a transmittance of a specific color, a control device that transmits a control signal to the optical device, and an operation device that instructs the control device to perform operation. As the optical device, a liquid crystal element capable of switching a plurality of different optical characteristics is used.

However, when the liquid crystal element is used, it is difficult to increase the light transmittance in a transparent state, such that visual recognition of a transmission-type element such as spectacles could hardly improve.

### SUMMARY

Example embodiments include an optical element using an electrochromic material capable of switching between a transparent state and a coloring state, including a spectrum assisting visual functions or visual perception ability, the spectrum being used for visual recognition of the optical element in the coloring state.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1A is a perspective view of spectacles according to embodiments;

FIG. 1B is a cross-sectional view of an optical lens device according to embodiments;

FIG. 2 is a block diagram illustrating an example of electrical components of the spectacles;

FIG. 3 is an explanatory graph of drive control by a control device, according to embodiments;

FIG. 4 is a graph illustrating a color vision correction spectrum characteristic curve according to embodiments;

FIG. 5 is a flowchart of applied voltage change control of the spectacles according to embodiments;

FIG. 6 is an explanatory graph of drive control according to a variation 1;

FIG. 7 is an explanatory graph of drive control according to a variation 2;

FIG. 8 is an explanatory diagram of spectacles according to a variation;

FIG. 9 is a cross-sectional view of an electrochromic element according to a variation; and

FIG. 10 is a graph of a transmittance measurement result of an example.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

In the following embodiments, spectacles having a pair of spectacle lenses is described. Each spectacle lens is implemented by an optical lens device (optical element) including an electrochromic element. Electrochromism is a phenomenon that an oxidation-reduction reaction occurs reversibly and a color reversibly changes when a voltage is applied. An electrochromic material exhibiting the electrochromism is generally formed between two opposing electrodes, and undergoes the oxidation-reduction reaction in a configuration in which an electrolyte layer capable of conducting ion is filled between the electrodes. In a case where a reduction reaction occurs in the vicinity of one of the two opposing electrodes, an oxidation reaction, which is a reverse reaction, occurs in the vicinity of the other electrode. An element using the electrochromic material is an electrochromic element (device) in which color development occurs at both electrodes when voltage is applied to cause a change in color and optical density.

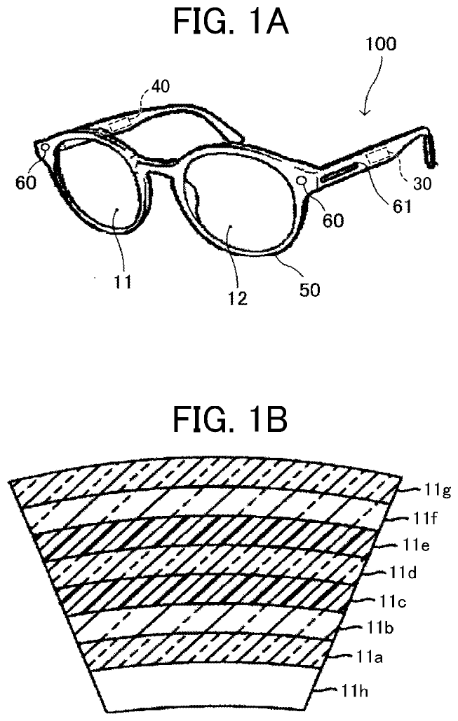

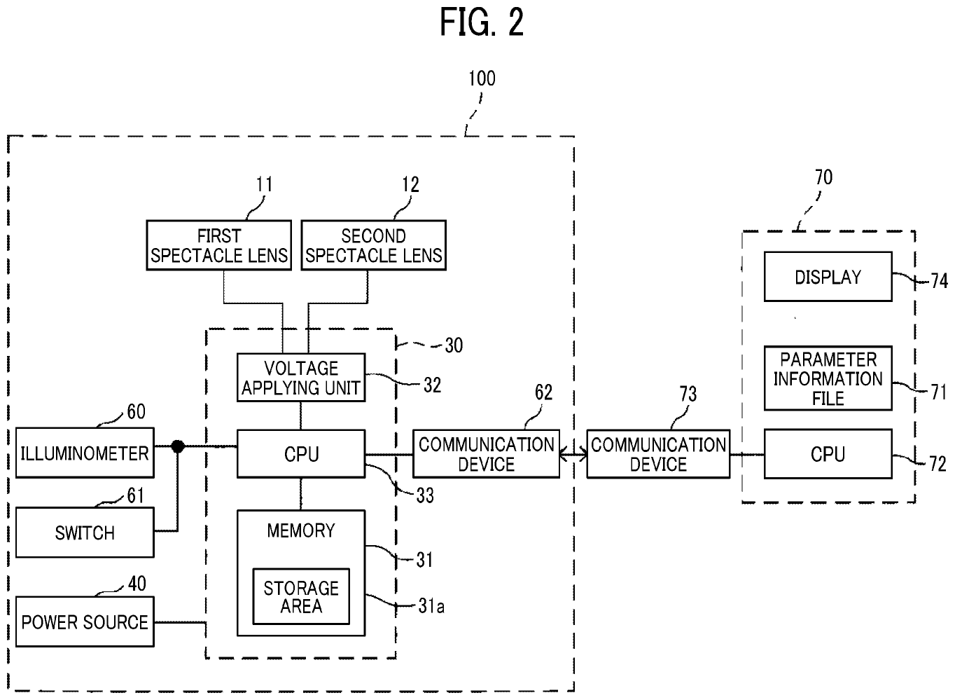

FIG. 1A is a perspective view of spectacles according to the embodiment. FIG. 1B is a cross-sectional view of an optical lens device according to the embodiment. Spectacles 100 include a first spectacle lens 11 and a second spectacle lens 12 as the optical lens devices, and a frame 50. Each of the first spectacle lens 11 and the second spectacle lens 12 has the electrochromic element and is processed in shape according to a rim shape of the frame 50. The first and second spectacle lenses 11 and 12 are incorporated in the frame 50. The frame 50 is provided with an illuminometer 60, a switch 61, a power source (refer to FIG. 2) and the like. The spectacles have a basic configuration that is substantially similar to that of the spectacles using the electrochromic element in the lens portion disclosed in JP-2018-10084-A.

FIG. 1B is a cross-sectional view of the optical lens device which forms the spectacle lens. An electrochromic element of FIG. 1B is provided on a lens substrate 11h. Specifically, a first electrode layer 11b and a first electrochromic (EC) layer 11c are formed on a first substrate 11a. A second electrode layer 11f and a second electrochromic layer 11d are formed on a second substrate 11g. A surface of the first electrochromic layer 11c and a surface of the second electrochromic layer 11d are disposed so as to face each other, with a gap provided between the first electrochromic layer 11c and the second electrochromic layer 11d. The first electrode layer 11b and the second electrode layer 11f are adhered to each other with an electrolyte layer 11e filled therebetween. In this manner, the electrochromic element is produced.

In the spectacles 100, when the electrochromic element is used as the lens, the electrochromic element is bent by thermoforming into a desired shape. After that, a resin is additionally formed on an outer surface of the bent electrochromic element to thicken the substrate. By grinding the thickened substrate, a desired curved surface is formed, and by performing a lens process (power process and the like) according to a user-specific condition, the lens may be obtained. Alternatively, a manufacturing process of adhering the bent electrochromic element to a manufactured lens (for example, resin lens) may be used.

In this embodiment, the optical lens device is a color vision correction lens having a spectrum capable of assisting color vision out of visual functions. Specifically, as the spectrum, a color vision correction spectrum characteristic curve used for converting a stimulation value proportion of three types of visual cone cells of a retina of a color-blind person is included. Accordingly, a material of the electrochromic (EC) layer 11c in particular of the electrochromic element is made of a material capable of obtaining a desired spectrum. Furthermore, a visual transmittance defined as a weighted light adaptation transmittance of a CIE standard illuminant D65 by a CIE 1932 2° standard observer of the optical lens device in a transparent state of the electrochromic material is made higher than 80%. Details and specific examples of the electrochromic element are described later. Since the optical lens device is the color vision correction lens, the spectacles 100 including the same may be said to be a color vision correction device.

FIG. 2 is a block diagram illustrating an example of an electrical component of the spectacles 100 as the color vision correction device.

The spectacles 100 include a control device 30 which applies a voltage to the first spectacle lens 11 and the second spectacle lens 12, a power source 40, the illuminometer 60 which is an ambient light detector, a switch 61 as an operation device, and a communication device 62.

The control device 30 includes a memory 31, a voltage applying unit 32, and a central processing unit (CPU) 33. The control device 30 controls the voltage applied to the first spectacle lens 11 and the second spectacle lens 12 by the voltage applying unit 32 based on a voltage applying condition. In this manner, density in a color developing state of the first spectacle lens 11 and the second spectacle lens 12 is adjusted. In the illustrated example, the control device 30 may independently control the first spectacle lens 11 and the second spectacle lens 12 in the spectacles as right and left lens portions.

The illuminometer 60 is connected to the CPU 33 of the control device 30 and outputs information on measured illuminance to the CPU 33. An installation place of the illuminometer 60 is not limited in particular. Preferably, the illuminometer 60 may be installed at a frame portion in the vicinity of the spectacle lenses 11 and 12, particularly a front portion, to measure ambient light (refer to FIG. 1A). In the illustrated example, each illuminometer 60 includes a pair of sensors corresponding to the right and left spectacle lenses 11 and 12, and each sensor is connected to the CPU 33. The power source 40 supplies power to an entire color vision correction device (spectacles 100). The switch 61 is used for powering on/off the spectacles 100 and for various operation commands. The switch 61 may be a push-button switch, a sliding switch, a touch sensor, and the like. The communication device 62 controls communication with a personal computer 70 which is an external device. The spectacles 100 of this embodiment perform the following control. That is, the control device 30 reads or writes the voltage applying condition from/on the memory 31 and allows the voltage applying unit 32 to apply the voltage to the first spectacle lens 11 and the second spectacle lens 12 based on the read voltage applying condition. The control device 30 allows the CPU 33 to perform an arithmetic operation of the information on the illuminance input from the illuminometer 60, and writes a new voltage applying condition obtained based on an arithmetic result on the memory 31.

The control device 30 has a function of rewriting information regarding processing of calculating a new voltage applying condition using the illuminance information, for example, a parameter that changes according to the illuminance and/or software in which a parameter calculating process is defined. More particularly, the memory 31 includes a storage area 31a for registering the parameter and/or software. The memory 31 also stores a setup module in the form of software, so as to control input of data regarding software from the external personal computer 70 to register and/or rewrite input data on the storage area 31a.

The personal computer 70 includes a CPU 72, a memory that stores a file 71 of information such as the parameter, a display 74, and a communication device 73 that enables the personal computer 70 to communicate with the spectacles 100. The communication devices 62 and 73 may each be any desired communication circuit of wired or wireless, but a communication circuit capable of performing wireless communication is preferable. A mobile terminal such as a smartphone may be used in place of the personal computer 70.

The following describes a method of applying a voltage for allowing the first spectacle lens 11 and the second spectacle lens 12 which are the optical lens devices illustrated in FIG. 1B to develop or erase color. For example, by applying a voltage between the first electrode layer 11b and the second electrode layer 11f, the first spectacle lens 11 and the second spectacle lens 12 develop a predetermined color. In a case where the second electrode layer 11f is grounded, a negative voltage is applied to the first electrode layer 11b. By applying an inverse voltage between the first electrode layer 11b and the second electrode layer 11f, the first spectacle lens 11 and the second spectacle lens 12 erase color to be transparent. In a case where the second electrode layer 11f is grounded, a positive voltage is applied to the first electrode layer 11b.

Depending on a characteristic of a material used for the electrochromic layer, there is a case of applying the negative voltage between the first electrode layer 11b and the second electrode layer 11f to develop color and of applying the positive voltage therebetween to erase color to be transparent. After developing color once, a color developing state may continue without applying the voltage between the first electrode layer 11b and the second electrode layer 11f.

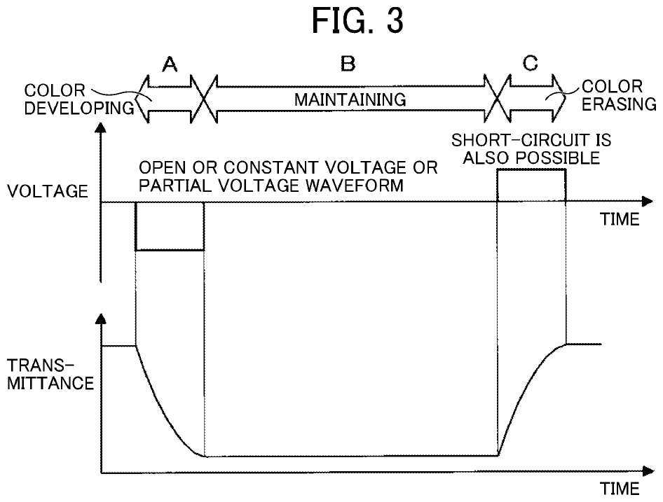

FIG. 3 is an explanatory graph of drive control by the control device 30. In an upper-half graph, time is plotted along the abscissa and the voltage applied to the first electrode layer 11b in a case where the second electrode layer 11f is grounded is plotted along the ordinate. In a lower-half graph, a time is plotted along the abscissa and a light transmittance (hereinafter, simply referred to as transmittance) is plotted along the ordinate. A period A is a color developing period. In such period, voltage is applied to shift from a transparent state in which the color is erased and the transmittance is high to a state in which the transmittance decreases and the color is developed to desired density. A maintaining period B is a period in which the color developing period is completed and the color developing state is maintained. A color erasing period C is a period in which the color is erased from the color developing state in the maintaining period to shift to an original transparent color erasing state.

In an example of FIG. 3, the negative voltage is continuously applied to the first electrode layer 11b during the color developing period A. During the color erasing period C, the positive voltage is continuously applied to the first electrode layer 11b. In the color erasing period C, the first electrode layer 11b may also be grounded instead of applying the positive voltage (the first electrode layer 11b and the second electrode layer 11f are short-circuited). During the maintaining period B, the first electrode layer 11b may be floated (the first electrode layer 11b and the second electrode layer 11f are opened). Alternatively, a negative constant voltage may be continuously applied to the first electrode layer 11b. Alternatively, a periodic fluctuation voltage (effective voltage is negative) which fluctuates periodically may be applied.

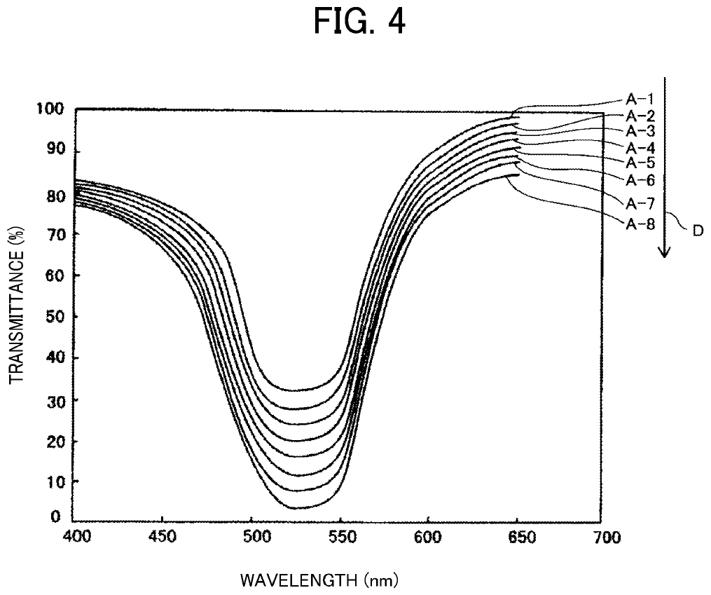

FIG. 4 is a graph illustrating one type (type A) out of four types of color vision correction spectrum characteristic curves of types A to D disclosed in JP-2018-10084-A. The color vision correction spectrum characteristic curves are the four types of color vision correction spectrum characteristic curves used for converting a stimulation value proportion of three types of visual cone cells of a retina of a color-blind person. They are said to be created based on the color vision correction spectrum characteristic curves divided into eight grades for one type and 32 grades in total, as disclosed in U.S. Pat. No. 5,369,453. In JP-2018-10084-A, it is premised that a color vision correction lens is prepared for each of the color vision correction spectrum characteristic curves of 32 grades in total.

This embodiment is to use the electrochromic element to obtain the color vision correction spectrum characteristic curves of a plurality of grades of the same type and all the eight grades of the same type, by adjusting the applied voltage of the same electrochromic element. For example, in the type A in FIG. 4, all the grades from A-1 to A-8 are obtained with lower transmittance and higher density in a coloring state as the characteristic curve is located lower as indicated by arrow D by adjusting the applied voltage.

In the example in FIG. 3, the larger an absolute value of the negative voltage applied in the color developing period A, and if the applied voltage is the same, the longer the developing period A, the more the transmittance decreases. As a result, the larger the absolute value of the negative voltage, the higher the density in the coloring state when it reaches the maintaining period B. It is possible to adjust the density in the colored state by the value of the voltage applied in the coloring period A and the voltage application time.

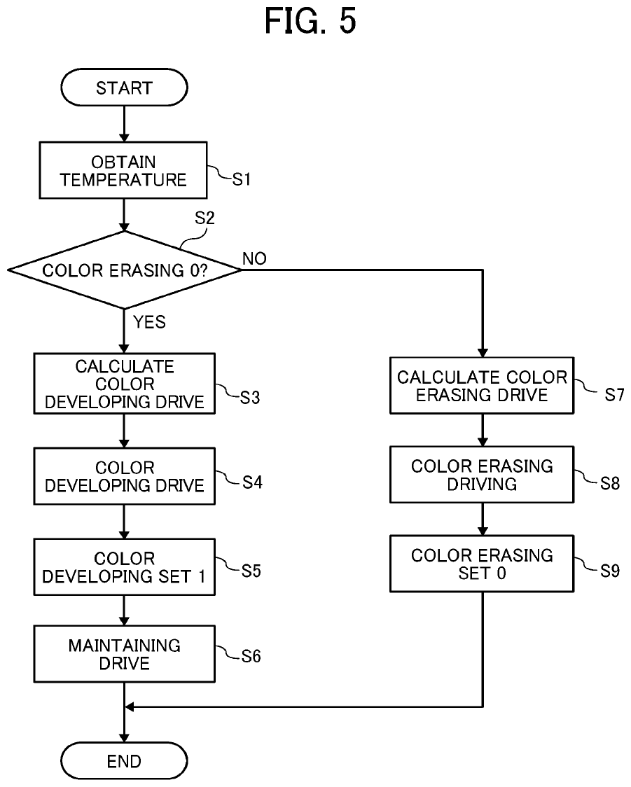

FIG. 5 is a flowchart illustrating operation of controlling applied voltage change of the spectacles, performed by the CPU 33, according to an embodiment. This applied voltage change control is executed when the switch 61 on the frame 50 of the spectacles 100 is operated to switch between color development and color erasing. At S1, information regarding the density is obtained. The information regarding the density is data of the grade suitable for a user of the spectacles and the illuminance information which is the measurement result from the illuminometer 60. The data of the grade suitable for the user of the spectacles is stored in the memory 31. Based on the data of the grade, by additionally using the illuminance information, a drive condition corresponding to target density used for determining the applied voltage and the like is obtained. Specifically, when the illuminance is high, the density in the color developing state is also increased accordingly.

In alternative to previously storing in the memory 31 the data of the grade suitable for the user of the spectacles, it is also possible to store in the memory 31 a program that executes operation of examining the suitable grade. In execution of the program in response to the operation command using the switch 61 and the like, the grade data is obtained as an examination result and stored in the memory 31. Alternatively, it is also possible to execute the examination while switching the density of the color developing state of the spectacles by an instruction from the personal computer 70 to execute the program for grade examination in cooperation with the external personal computer 70 and the like to be described later. It is also possible to store the examination result in a storage device (such as a memory) of the external personal computer 70 and appropriately transfer to the memory 31 of the spectacles.

It is also possible to record the grade data in the memory 31 of the spectacles by using the external personal computer 70 and the like based on a result of examination performed by a medical institution and the like. Such record corresponds to the instruction on the density used in the control device 30, and the personal computer 70 for this purpose serves as an input device via the communication device. The instruction on the density may be always issued from an external device such as the personal computer 70 in a communicating state.

The storage devices of the personal computer 70 and the mobile terminal correspond to external storage devices, and the external storage devices may be used as the storage devices of the density information such as the grade data. This information may be obtained through communication and used to control the density adjustment by the control device. It is also possible to set the density information such as the grade data in the memory 31 of the control device 30 by using the personal computer 70 or the mobile terminal.

At S2, the CPU33 determines whether the each spectacle is in a color erasing state “0” at that time. For this determination, a flag and the like which is set to 1 at the end of the color developing period A and set to 0 at the end of the color erasing period C is used. When it is determined that it is in the color erasing state, a drive condition for color developing drive is calculated at S3.

The above-described calculation is performed using the illuminance information. The parameters that change according to the illuminance may be discrete parameters corresponding to an illuminance range divided into a plurality of sections (ranges). It is possible to discretely determine magnitude and length of application time of the applied voltage used in the color developing period A for each of three ranges of high, medium, and low. The determined values are then stored in the memory 31 in the form of a look-up table or embedded (programmed) into the software stored in the storage area 31a. Alternatively, the parameters that change according to the illuminance may be continuous parameters calculated from a function having the illuminance as a variable.

At S4, the CPU 33 performs color developing using the calculated parameters. When the color developing is completed, the flag is set to “1”, and the operation proceeds to S6, to start maintaining operation, and the operation ends. The parameters used for the maintaining drive may be calculated using the grade data and illuminance information.

In a case where it is determined that it is not in the color erasing state “0”, that is, it is in the color developing state at S2 described above, the operation proceeds to S7 to calculate a drive condition for color erasing drive. This calculation is also performed by using the grade data and illuminance information. The parameters that change according to the illuminance may be discrete or continuous as at S3.

The CPU 33 performs color erasing at S8 using the calculated parameters, and when this is completed, the flag is set to “0” and the operation ends.

Alternatively, it is also possible to store information of density setting according to a usage condition such as density suitable for spending time indoors, density suitable for sunny day, and density suitable for cloudy day in the memory 31.

The user of the spectacles executes operation for switching between the transparent state and the color developing state and operation for adjusting the density through the switch 61, the personal computer 70, and the external communication device. At that time, it is also possible to adjust the density according to preference of the user without using the illuminance information from the illuminometer 60.

The user of the spectacles may normally wear the spectacles in the transparent state and switch to the color developing state when he/she wants to improve the visual function. It is also possible to adjust the density in a scene where the illuminance changes, such as when the user goes outdoors from indoors during the day.

It is also possible to adjust the density while calling the information of density setting according to the usage condition recorded in advance.

When the personal computer or the external communication device are used for the density adjustment, it is desirable that a color pattern of a display screen is determined based on a color universal design such that colors that can be easily distinguishable by a color-blind person are used. It is also possible to switch the display screen of the personal computer and the external communication device when switching the spectacles to the color developing state to display the color pattern that may be difficult for the color-blind person to distinguish. This allows the user to check whether the color vision correction of the spectacles functions by looking at the color pattern which is difficult to distinguish in the transparent state.

In a case where a battery level of the power source runs out in the color developing state, it is not possible to shift to the color erasing state, so that it is difficult to work in a dark place and dangerous. Therefore, in a case where the battery level becomes low in the color developing state, it is possible to control to automatically shift to the color erasing state. At that time, a warning may be given to the user by a speaker or a light emitting diode (LED) mounted on the spectacles. As a device of detecting the battery level, the control device may have a function of measuring the voltage of the battery.

In a color vision correction application, it is also possible to image the front by using a camera mounted on the spectacles to drive the control device in a case where color combination difficult for the color-blind person to distinguish is in front, thereby shifting from the color erasing state to the coloring state.

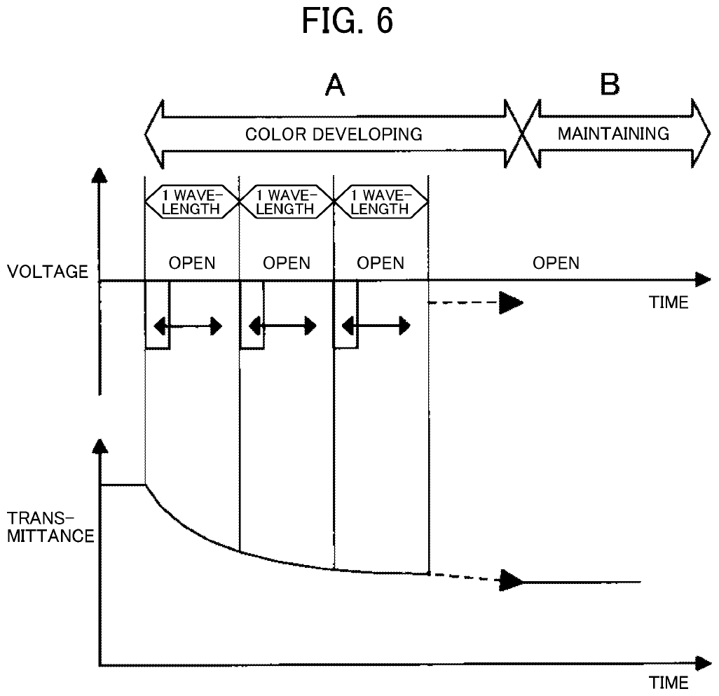

FIG. 6 is an explanatory graph of drive control according to a variation. In this variation 1, as the applied voltage in the color developing period A, a periodic fluctuation voltage which fluctuates periodically is used. Specifically, an intermittent voltage including ON and OFF (float/opening of the first electrode layer 11b) is used. Depending on the grade data and illuminance, a duty ratio being a ratio of an ON time in one period (application time ratio of the voltage of a relatively large value in one period) is changed. Specifically, it is changed such that a duty increases as the density corresponding to the grade data and illuminance is higher. In FIG. 6, the change in duty ratio is indicated by an arrow.

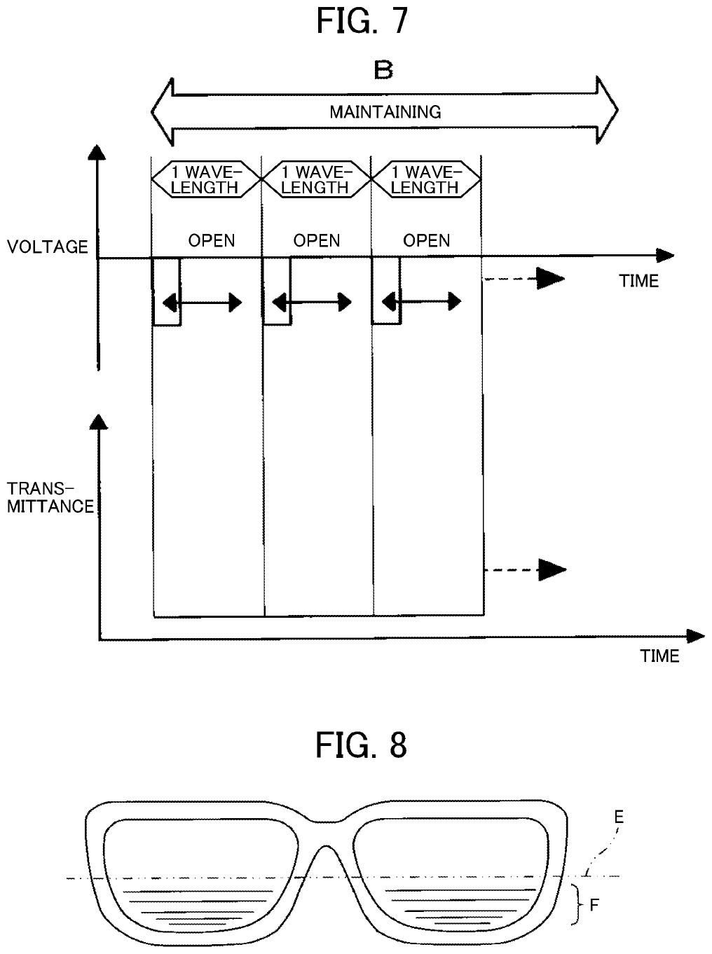

FIG. 7 is an explanatory graph of drive control according to a variation 2. In this example, the same intermittent voltage as that in the variation 1 is used in the maintaining period B. The duty ratio is changed depending on the temperature. Specifically, it is changed such that a duty increases as the density corresponding to the grade data and illuminance is higher. It is also possible to use the similar intermittent voltage during the color erasing period C and change the duty ratio depending on the illuminance.

As described above, the optical lens device of this embodiment has a spectrum that can improve color discriminating ability and adjust in the transparent state, so that it is possible to improve the color discriminating ability of the user, maintain a range of view bright when not used, and realize a transparent appearance. Since the color vision correction spectrum characteristic curve used for converting the stimulation value proportion of three types of visual cone cells of the retina of the color-blind person is used, it is possible to improve the color discriminating ability of the color-blind person who uses the same.

In a case where a liquid crystal element is used, the visual transmittance is generally 50% or lower even in the color erasing state, so that it is not transparent but a dark state such as gray. Even when the color is erased, it brings discomfort, and the range of view is too dark indoors, which poses a practical problem. Since a polarization phenomenon of the liquid crystal is used, this cancels display of a liquid crystal television and a liquid crystal display which also use the polarization phenomenon, and sometimes it is difficult to visually recognize. Since an entire field of view is periodically flickered for the purpose of color discrimination, discomfort during use is strong and long-term use is difficult. It is necessary to continuously apply a current for a long time to drive the liquid crystal element, and power consumption is large.

In contrast, in this example, sufficient transparency may be obtained. Moreover, electrochromic has a memory property, and once this is colored, the coloring state is maintained, so that power consumption is low. The transparent state and a color vision correcting state may be switched.

Since the electrochromic material has the spectrum which improves the color discriminating ability, intensity of the color vision correction and the transmittance may be adjusted according to a charge amount due to the voltage application.

It is possible to adjust the intensity of the color vision correction and the transmittance by a density adjusting mechanism which electrically controls the electrochromic material.

Since the visual transmittance is 70% or higher, it is possible to sufficiently secure brightness of the range of view when worn indoors in the transparent state.

The input using the switch 61 or adjustment of coloring density through the personal computer 70 as an external information terminal may be performed.

Since user information is recorded in the control device, the color vision may be corrected with the coloring density according to the user.

Since the user information is recorded in an external storage terminal, the color vision may be corrected with the coloring density according to the user.

Since the optical element has a function of adjusting the coloring density according to the brightness of the surroundings, it is possible to perform the color vision correction while securing the brightness of the range of view even in a case where the brightness of ambient light is weak such as within doors.

Since the optical element has a spectacle shape, it may be worn on the face to utilize a color vision correcting effect.

In the coloring state, a gradient of the coloring density may be generated in a plane of the optical element. FIG. 8 is an explanatory diagram thereof. Color is developed only in an area F below a center line E of the lens portion. According to this, it is possible to achieve the color vision correction while securing the brightness of the range of view in a part of the field of view. In the illustrated example, the density is higher in a lower portion of the area E. The gradient of the coloring density may be obtained by making a gradient of a concentration of the electrochromic compound.

An upper half of the spectacle lens may be transparent, for example, and a lower half may have a uniform density to some extent. For this purpose, the electrochromic layer may be formed only in the lower half, or the electrochromic layer may be formed in an entire portion and electrodes are divided into upper and lower ones so that they may be individually driven.

In an example illustrated in FIG. 2, since the coloring densities of right and left optical elements may be adjusted independently, it is possible to control to develop color of only one (for example, left) lens portion and keep the other transparent, thereby achieving the color vision correction with one eye while securing the brightness of the range of view with the other eye.

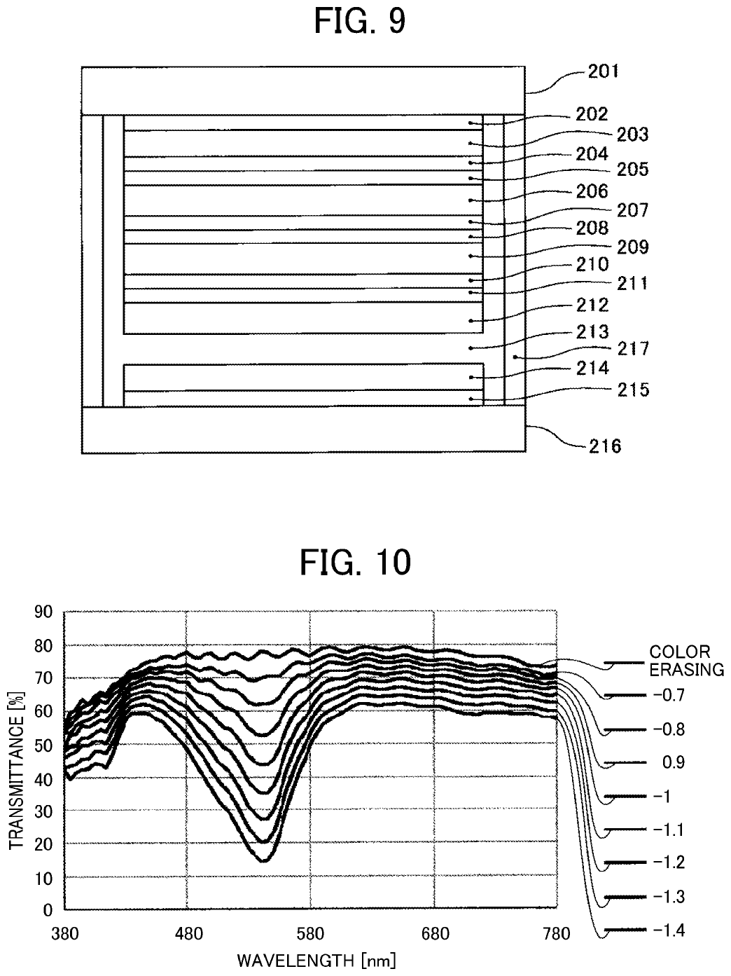

As illustrated in FIG. 9, four electrochromic layers corresponding to the above-described four types (A to D) of color vision correction spectrum characteristic curves may be stacked. An electrochromic display element includes the four electrochromic layers between two facing substrates, and a space between the substrates is filled with an electrolyte layer.

From the top in the drawing, a first substrate 201, a first electrode layer 202, a first electrochromic layer 203, a first insulating inorganic particle layer 204, a second electrode layer 205, a second electrochromic layer 206, a second insulating inorganic particle layer 207, a third electrode layer 208, a third electrochromic layer 209, a third insulating inorganic particle layer 210, a fourth electrode layer 211, a fourth electrochromic layer 212, an electrolyte layer 213, a deterioration prevention layer 214, a counter electrode 215, a second substrate 216, and a sealing material 217 are included.

Since the color development in each electrochromic layer is determined by magnitude of the voltage generated between the corresponding electrode and the counter electrode, the voltage may control color development/erasing of each electrochromic layer and the density in the color developing state. If the four electrochromic layers are configured so as to obtain the above-described four types (A to D) of color vision correction spectrum characteristic curves, it is possible to meet all the types and all the grades of each type.

Such a configuration in which a plurality of electrochromic layers is stacked may be used to realize any one of the four types (A to D) of color vision correction spectrum characteristic curves by a plurality of electrochromic layers.

According to at least one embodiment of the present invention, since the electrochromic material is used, it is easy to increase the light transmittance in the transparent state as compared with a case where the liquid crystal is used.

Although the present invention is heretofore described with reference to the embodiment in which the optical lens device which is the optical element including the electrochromic device has the spectrum for color vision correction, this may also be applied to that having the spectrum capable of maintaining other visual functions (eyesight, field of view, ocular motility, contrast sensitivity, and binocular function) and visual perception ability (perception of length, size, position, motion, inclination, and figure). For example, a color lens or color film referred to as an Irlen lens is known for “Irlen syndrome” which is one of disorders of visual perception found by a British educational psychologist. The optical lens device including the electrochromic material may have the same spectrum as that of such color lens or color film.

The optical element in this disclosure may also be used for a medical light-shielding lens for preventing photophobia as disclosed in JP-5650963-B. In JP-5650963-B, photophobia is prevented by selectively blocking light having wavelengths of 505 nm and 555 nm; however, it is possible to obtain an effect of preventing photophobia by selectively blocking light having a specific wavelength.

Although the embodiment applied to the spectacles in which the optical lens device is incorporated as the spectacle lens is described above, the optical element of this embodiment is also applicable to goggles and sunglasses in which the lens portion does not have a refractive index (strictly, this is not a lens). The optical element in this disclosure may also be applied to a monocular hand-held lens or spectacles worn on the head. Furthermore, the form is not limited in particular as long as the optical element is a transmission type optical element to visually recognize an object or the like. Further, the optical element may be applied to various shapes such as a sheet suitable for being held by the hand for looking at an object through the sheet, a partition shape, and the like. In a case where the optical element is formed into the sheet shape, it may be used as an electrochromic sheet itself, or may be adhered to or embedded in a transparent base material to be used. The optical element in this disclosure may also be applied to a window glass of a building and a window glass of a vehicle such as a car.

Although an example of the electrochromic device stable in the color erasing state is described, the device which develops color in a normal state and erases color, further develops color, or changes hue by oxidation and reduction referred to as a normally colored is not excluded. That is, by the oxidation or reduction from the stable state, a predetermined state 1 and a state 2 with color different from the state 1 switch. This means that any one of the state 1 and the state 2 is stable and any one of them is transparent.

Here, details and specific examples of the electrochromic element are described. As the electrochromic element, it is preferable that a first substrate, a first electrode layer, a first electrochromic layer, a second electrochromic layer, a second electrode layer, and a second substrate are included in this order, and an electrolyte is included between the first electrode layer and the second electrode layer. An insulating inorganic particle layer may be included between the first electrochromic layer and the second electrochromic layer if necessary. In a case where the first electrochromic layer or the second electrochromic layer is not used and the electrochromic element is formed only by using one electrochromic layer, it is preferable to form a deterioration prevention layer on the electrode layer not using the electrochromic layer.

### First Substrate and Second Substrate

The first substrate and the second substrate (hereinafter, in a case where neither is specified, they are sometimes simply referred to as “substrates”) are not limited in particular, and well-known thermoformable resin material may be appropriately selected as-is depending on its application; there are, for example, resin substrates of a polycarbonate resin, an acrylic resin, a polyethylene resin, a polyvinyl chloride resin, a polyester resin, an epoxy resin, a melamine resin, a phenol resin, a polyurethane resin, a polyimide resin and the like.

A surface of the substrate may be coated with a transparent insulating inorganic particle layer, an antireflection layer, and the like in order to improve a water vapor barrier property, a gas barrier property, and visibility.

A shape of the substrate is not limited in particular and may be appropriately selected according to the intended application; for example, there are an elliptical shape, a rectangular shape, and the like. In a case where the color vision correction device is used as the color vision correction spectacles, it is also possible to make the first substrate the lens and make an outer shape of the first substrate a shape according to a rim of the frame.

### First Electrode Layer and Second Electrode Layer

A material of the first electrode layer and the second electrode layer (hereinafter, in a case where neither is specified, they are sometimes simply referred to as “electrode layers”) is not limited in particular as long as this is a transparent material having conductivity, this may be appropriately selected depending its application, and there are, for example, tin-doped indium oxide (hereinafter, sometimes also referred to as “ITO”), fluorine-doped tin oxide (hereinafter, sometimes also referred to as “FTO”), antimony-doped tin oxide (hereinafter, sometimes also referred to as “ATO”) and the like. It is preferable to include, among them, at least any one of indium oxide (hereinafter, sometimes also referred to as “In oxide”), tin oxide (hereinafter, sometimes also referred to as “Sn oxide”), and zinc oxide (hereinafter, sometimes also referred to as “Zn oxide”) formed by vacuum film formation from the viewpoint that they are materials easily formed by sputtering and that excellent transparency and electroconductivity may be obtained. Among them, InSnO, GaZnO, SnO, In₂O₃, and ZnO are preferable in particular. Furthermore, a network electrode of silver, gold, carbon nanotube, metal oxide and the like having transparency and a composite layer of them are also useful.

An average thickness of the electrode layer is not limited in particular and may be appropriately selected depending on its application; however, it is preferably adjusted such that an electrical resistance value required for oxidation-reduction reaction of electrochromic may be obtained, and this is preferably 50 nm or larger and 500 nm or smaller in a case where ITO is used.

### First Electrochromic Layer and Second Electrochromic Layer

The first electrochromic layer and the second electrochromic layer are not limited in particular as long as they include the electrochromic material to have the spectrum capable of improving the color discriminating ability and they may be appropriately selected according to the intended application.

The electrochromic material is not limited in particular and may be appropriately selected depending on its application; there are, for example, an inorganic electrochromic compound, an organic electrochromic compound, and a conductive high molecule known to exhibit electrochromism.

Examples of the inorganic electrochromic compound include a tungsten oxide, a molybdenum oxide, an iridium oxide, and a titanium oxide, for example.

Examples of the organic electrochromic compound include viologen, rare earth phthalocyanine, styryl, triarylamine, or derivatives thereof, for example.

Examples of the conductive high molecule include polypyrrole, polythiophene, polyaniline, or derivatives thereof, for example.

As the electrochromic layer, a structure in which a conductive or semiconductor microparticle supports the organic electrochromic compound may be used.

Specifically, this is the structure in which the microparticles of particle diameters of about 5 nm to 50 nm are sintered on an electrode surface, and a surface of the microparticle absorbs the organic electrochromic compound having a polar group such as a phosphonic acid and carboxyl group, and a silanol group.

Since electrons are efficiently injected into the organic electrochromic compound by utilizing a large surface effect of the microparticle, this structure responds quickly as compared to a conventional electrochromic display element.

Furthermore, since it is possible to form a transparent film by using the microparticle, high color developing density of an electrochromic pigment may be obtained.

It is also possible that the conductive or semiconductor microparticles support a plurality of types of organic electrochromic compounds.

As the electrochromic material, there specifically are azobenzene series, anthraquinone series, diarylethene series, dihydroprene series, dipyridine series, styryl series, styryl spiropyran series, spirooxazine series, spirothiopyran series, thioindigo series, tetrathiafulvalene series, terephthalic acid series, triphenylmethane series, triphenylamine series, naphthopyran series, viologen series, pyrazoline series, phenazine series, phenylenediamine series, phenoxazine series, phenothiazine series, phthalocyanine series, fluoran series, fulgide series, benzopyran series, and metallocene series low molecule organic electrochromic compounds, and conductive high molecule compounds such as polyaniline and polythiophene as polymer series and pigment series electrochromic compounds.

Examples of the viologen series compound include, for example, the compound disclosed in JP-3955641-B and JP-2007-171781-A.

Examples of the dipyridine series compound include, for example, the compound disclosed in JP-2007-171781-A and JP-2008-116718-A.

Among them, the dipyridine series compound expressed by the following General Formula 1 is preferable from the viewpoint of exhibiting an excellent color developing color value.

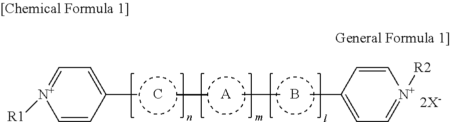

However, in General Formula 1 described above, R1 and R2 represent an alkyl group or an aryl group of carbon number of 1 to 8 which may independently have a substituent group, and at least one of R1 and R2 has the substituent group selected from COOH, PO(OH)₂, and Si(OCₖH₂ₖ₊₁)₃ (where k is 1 to 20). X represents a monovalent anion, and for example, there are Br ion (Br⁻), Cl ion (Cl⁻), ClO₄ ion (ClO₄⁻), PF₆ ion (PF₆⁻), BF₄ ion (BF₄⁻) and the like though this is not limited in particular as long as this stably forms a pair with a cation. n, m, and 1 represent 0, 1, or 2. A, B, and C represent an alkyl group, an aryl group, or a heterocyclic group of carbon number of 1 to 20 which may independently have a substituted group.

Examples of a metal complex series or metal oxide series electrochromic compound include, for example, an inorganic electrochromic compound such as titanium oxide, vanadium oxide, tungsten oxide, indium oxide, iridium oxide, nickel oxide, Prussian blue, and the like.

The conductive or semiconductor microparticles are not limited in particular and may be appropriately selected according to the purpose; however, metal oxides are preferable.

Examples of a material of the metal oxide include, for example, titanium oxide, zinc oxide, tin oxide, zirconium oxide, cerium oxide, yttrium oxide, boron oxide, magnesium oxide, strontium titanate, potassium titanate, barium titanate, calcium titanate, calcium oxide, ferrite, hafnium oxide, tungsten oxide, iron oxide, copper oxide, nickel oxide, cobalt oxide, barium oxide, strontium oxide, vanadium oxide, aluminosilicate, calcium phosphate, and metal oxide containing aluminosilicate and the like as a principal component. They may be used alone or two or more of them may be used in combination.

Considering an electric characteristic such as electric conductivity and a physical characteristic such as an optical property, when one selected from titanium oxide, zinc oxide, tin oxide, zirconium oxide, iron oxide, magnesium oxide, indium oxide, and tungsten oxide or a mixture thereof is used, color display excellent in response speed of color development/erasing is possible.

Especially, when titanium oxide is used, color display more excellent in response speed of color development/erasing is possible.

Although a shape of the conductive or semiconductor microparticle is not limited in particular, in order to efficiently support the electrochromic compound, a shape having a large surface area per unit volume (hereinafter, referred to as a specific surface area) is used.

For example, when the microparticle is aggregation of nanoparticles, this has a large specific surface area, so that the electrochromic compounds are more efficiently supported, and a display contrast ratio of color development/erasing is excellent.

An average thickness of the electrochromic layer is not limited in particular and may be appropriately selected depending on the purpose; however, this is preferably 0.2 μm or larger and 5.0 μm or smaller. When the average thickness of the electrochromic layer is smaller than 0.2 μm, the color developing density is sometimes obtained with difficulty, and when this is larger than 5.0 μm, a manufacturing cost increases and visibility is sometimes deteriorated by the color development.

The electrochromic layer and the conductive or semiconductor microparticle layer may be formed by vacuum film formation; however, it is preferable to apply to form in terms of productivity.

### Deterioration Prevention Layer

A role of a deterioration prevention layer is to perform a reverse reaction with the electrochromic layer to suppress corrosion and deterioration by irreversible oxidation-reduction reaction of the electrode. The reverse reaction includes a case where the deterioration prevention layer serves as a capacitor in addition to the case where this is oxidized/reduced.

A material of the deterioration prevention layer is not limited in particular as long as this is a material to prevent corrosion of the electrode due to the irreversible oxidation-reduction reaction, and may be appropriately selected according to the purpose. As the material of the deterioration prevention layer, for example, antimony tin oxide, nickel oxide, titanium oxide, zinc oxide, tin oxide, or a conductive or semiconductor metal oxide containing a plurality of them may be used. The deterioration prevention layer may be formed by using a porous thin film which does not hinder injection of the electrolyte. For example, by fixing conductive or semiconductor metal oxide microparticles such as antimony tin oxide, nickel oxide, titanium oxide, zinc oxide, and tin oxide to the second electrode by acrylic, alkyd, isocyanate, urethane, epoxy, and phenol binder, for example, it is possible to obtain a preferable porous thin film which satisfies permeability of the electrolyte and a function as the deterioration prevention layer.

### Electrolyte

The electrolyte is filled between the first electrode and the second electrode.

As the electrolyte, for example, inorganic ion salt such as alkali metal salt and alkali earth metal salt; quaternary ammonium salt, and supporting salts of acids and alkalis may be used, and specifically, LiClO₄, LiBF₄, LiAsF₆, LiPF₆, LiCF₃SO₃, LiCF₃COO, KCl, NaClO₄, NaCl, NaBF₄, NaSCN, KBF₄, Mg(ClO₄)₂, Mg(BF₄)₂ and the like are included. They may be used alone or two or more of them may be used in combination.

An ionic liquid may also be used as the material of the electrolyte. Among them, organic ionic liquid is preferably used because this has a molecular structure as liquid in a wide temperature range including room temperature.

Examples of the molecular structure as liquid in the wide temperature range including the room temperature include, as cation components, imidazole derivatives such as N,N-dimethylimidazole salt, N,N-methylethylimidazole salt, and N,N-methylpropylimidazole salt; pyridinium derivatives such as N,N-dimethylpyridinium salt and N,N-methylpropylpyridinium salt; and aliphatic quaternary ammonium salts such as trimethylpropylammonium salt, trimethylhexylammonium salt, and triethylhexylammonium salt, for example. From the viewpoint of stability in the air, it is preferable to use a compound containing fluorine as anion components, and examples thereof include, for example, BF₄⁻, CF₃SO₃⁻, PF₄⁻, (CF₃SO₂)₂N⁻ and the like. They may be used alone or two or more of them may be used in combination.

As the material of the electrolyte, it is preferable to use the ionic liquid in which the cation component and the anion component are arbitrarily combined.

The ionic liquid may be directly dissolved in any of photopolymerizable monomer, oligomer, and liquid crystal material. In a case where dissolubility is poor, a solution dissolved in a small amount of solvent may be mixed with any one of the photopolymerizable monomer, oligomer, and liquid crystal material to be used.

Examples of the solvent include propylene carbonate, acetonitrile, γ-butyrolactone, ethylene carbonate, sulfolane, dioxolane, tetrahydrofuran, 2-methyltetrahydrofuran, dimethylsulfoxide, 1,2-dimethoxyethane, 1,2-ethoxymethoxyethane, polyethylene glycol, alcohols, and the like, for example. They may be used alone or two or more of them may be used in combination.

The electrolyte does not have to be low-viscosity liquid, and may take various forms such as gel, cross-linking polymer, and liquid crystal dispersion type. It is advantageous to form the electrolyte in a gel or solid state from the viewpoint of improving element strength and reliability.

As a solidification method, it is preferable to retain the electrolyte and the solvent in the polymer from the viewpoint of obtaining high ionic conductivity and solid strength.

As the polymer, the photocurable resin is preferable from the viewpoint that the element may be manufactured at lower temperature in a shorter time than in a method of thinning by thermal polymerization and evaporation of the solvent.

An average thickness of the electrolyte layer including the electrolyte is not limited in particular and may be appropriately selected depending on the purpose; this is preferably 100 nm or larger and 100 μm or smaller.

### Other Layers

Other layers are not limited in particular and may be appropriately selected depending on the purpose; for example, an insulating inorganic particle layer, a protective layer and the like may be mentioned.

### Insulating Inorganic Particle Layer

The insulating inorganic particle layer is a layer for separating the first electrode layer and the second electrode layer such that they are electrically insulated. A material of the insulating inorganic particle layer is not limited in particular, but an organic material, an inorganic material, or a complex thereof excellent in insulating property, durability, and film formation property is preferable. As a forming method of the insulating inorganic particle layer, for example, well-known forming methods such as a sintering method (of adding high molecule microparticles and inorganic particles to a binder and the like to be partially fused and utilizing a hole generated between particles), an extracting method (of forming a composition layer by an organic material or an inorganic material soluble to a solvent, a binder not dissolved in the solvent and the like and thereafter dissolving the organic material or the inorganic material by the solvent to obtain a thin hole), a foaming method of foaming by heating or degassing a high molecular weight polymer and the like, a phase inverting method of phase-separating a mixture of high molecules by operating an excellent solvent and a poor solvent, and a radiation emitting method of radiating various radiations to form a thin hole may be used. Specifically, there are a resin mixed particle film including a metal oxide microparticle (for example, a SiO₂ particle, an Al₂O₃ particle and the like) and a resin binding agent, a porous organic film (for example, a polyurethane resin, a polyethylene resin and the like), an inorganic insulating material film formed on a porous film and the like.

### Protective Layer

The protective layer is formed to physically and chemically protect a side surface of the electrochromic element.

The protective layer may be formed by applying, for example, an ultraviolet curable insulating resin, a thermosetting insulating resin and the like so as to cover at least any of a side surface and an upper surface, and curing the same thereafter. It is further preferable to make a stacked protective layer of the curing resin and the inorganic material. By making a stacked structure with the inorganic material, a barrier property against oxygen and water is improved.

Examples of the present invention are hereinafter described, but the present invention is not at all limited to these examples.

### MANUFACTURING EXAMPLE 1

### Example of Electrochromic Material for Type A

As the electrochromic compound for obtaining the color vision correction spectrum characteristic curve of the type A, the “exemplified compound 1” expressed by the following structural formula disclosed in paragraph 0039 of JP-2017-008025-A was suitable.

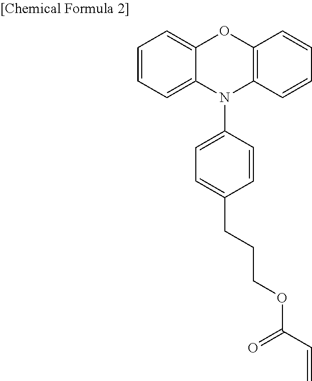 [SMILES: C=CC(=O)OCCCc1ccc(N2c3ccccc3Oc3ccccc32)cc1]

### Synthesis of Electrochromic Compound

The exemplified compound 1 was synthesized according to the following scheme.

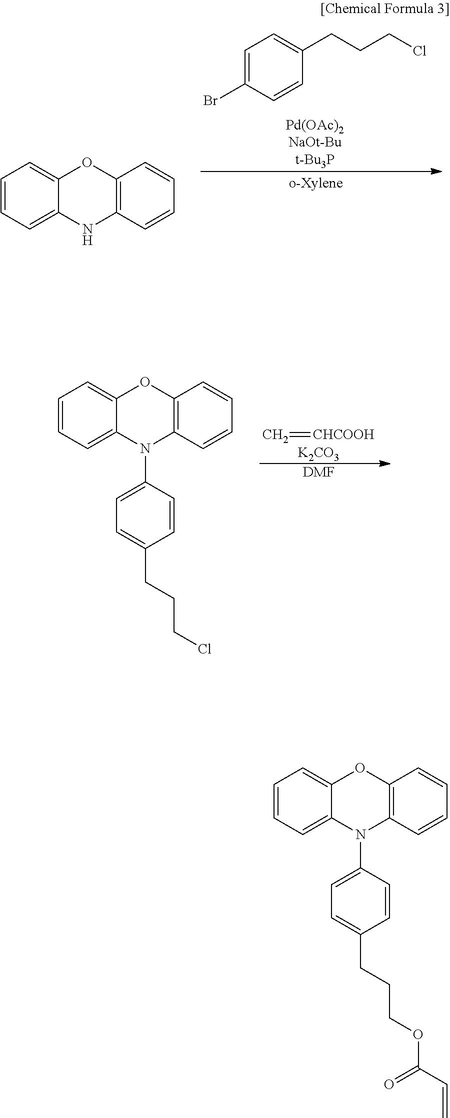

### Synthesis of Intermediate 1-1

Phenoxazine (18.3 g, 100 mmol), 1-bromo-4-(3-chloropropyl)benzene (23.4 g, 100 mmol), palladium acetate (225 mg, 1.0 mmol), sodium t-butoxide (14.4 g, 150 mmol), and o-xylene (420 mL) were put into a nitrogen-substituted flask, the solution was bubbled with argon gas, thereafter tetrakis(tri-t-butylphosphine) (624 mg, 3.08 mmol) was added, and the mixture was heated and stirred at 115° C. for two hours. The reaction solution was returned to room temperature and filtered through celite. Next, the separated organic phase was condensed, the residue was subjected to silica gel column chromatography (stationary phase: neutral silica gel, mobile phase: hexane/toluene) for purification, and an intermediate 1-1 expressed by the following structural formula was obtained as a pale yellow oily substance (yield 30.2 g, 90% by mass).

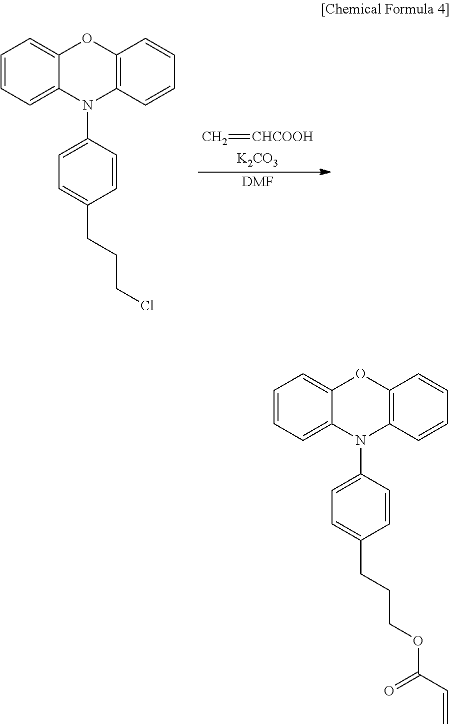

### Synthesis of Electrochromic Compound 1

The intermediate 1-1 (10.0 g, 29.8 mmol), acrylic acid (4.29 g, 59.6 mmol), potassium carbonate (6.21 g, 45.0 mmol), and N,N-dimethylformamide (DMF, 32 mL) were put into a nitrogen-substituted flask, and the solution was heated and stirred at 80° C. for 20 hours. After cooling the solution to room temperature, ethyl acetate and water were added, an organic phase was separated, and an aqueous phase was extracted three times with ethyl acetate. The combined organic phase was washed with water and then with saturated saline, and thereafter dried with sodium sulfate. Desiccant was filtered and the condensed residue was subjected to silica gel column chromatography (stationary phase: neutral cilica gel, mobile phase: hexane/ethyl acetate) for purification, and the electrochromic compound 1 was obtained as a white solid (yield 10.6 g, 96% by mass).

When the MS spectrum (ESI) of the electrochromic compound 1 was measured with the ASAP probe of the LCT Premier (device name) manufactured by Waters (U.S.) in ESI (measurement mode), the theoretical value was 371.15 and the measured value was 371.2, and this was confirmed to be the electrochromic compound 1 expressed by structural formula of Chemical Formula 3.

### Production of Electrochromic Element

### Production of First Substrate

As a first substrate, an elliptical polycarbonate substrate having a major axis length of 80 mm, a minor axis length of 55 mm, and an average thickness of 0.5 mm was produced.

### Formation of First Electrode Layer

An ITO film having an average thickness of 100 nm was formed on the first substrate as a first electrode layer by sputtering.

### Formation of First Electrochromic Layer on First Electrode Layer

In order to form the first electrochromic layer on the first electrode layer, an electrochromic composition having a composition below was prepared. The electrochromic compound 1, AME-400 (manufactured by NOF CORPORATION), KAYAMER PM-21 (manufactured by Nippon Kayaku Co., Ltd.), IRGACURE 819 (manufactured by BASF Japan Ltd.), and cyclohexanone (manufactured by Tokyo Chemical Industry Co., Ltd.) were mixed at 12:7.5:0.5:0.08:55 (mass ratio) to prepare the electrochromic composition.

The obtained electrochromic composition was applied to the first electrode, and the obtained coating film was UV-irradiated by a UV irradiation device (SPOT CURE manufactured by Ushio Inc.), and the first electrochromic film having an average thickness of 500 μm was formed.

### Production of Second Substrate

As a second substrate, a polycarbonate substrate similar to the first substrate was prepared.

### Formation of Second Electrode Layer

An ITO film having an average thickness of 100 nm was formed on the second substrate as a second electrode layer by sputtering.

### Formation of Deterioration Prevention Layer on Second Electrode Layer

A coating film including tin oxide was formed as the deterioration prevention layer on the second electrode layer. The coating film was produced as follows.

Tin oxide sol solution (Cellnax CX-S510M, manufactured by Nissan Chemical Corporation): 5.50 g, ethyl cellulose (10 cp, 10 wt %, ethanol solution):1.00 g, Tin(IV)tetra(t-butoxide):0.50 g, terpineol:9.05 g were mixed and treated with an ultrasonic homogenizer for two minutes, thereafter volatile elements were removed by an evaporator to obtain a target paste. This paste was applied to a film thickness of 3.5 μm by a screen printing machine and dried with warm air (120° C., five minutes).

### Formation of Electrolyte

IRGACURE 184 (manufactured by BASF Japan Ltd.), AME-400 (manufactured by NOF CORPORATION), ADE-400A (manufactured by NOF CORPORATION), and 1-ethyl-3-methylimidazolium bis(trifluoromethanesulfonyl)imide (manufactured by Kanto Chemical CO.,INC.) were mixed at 0.1:10:10:50 (mass ratio) to prepare electrolyte solution. The obtained electrolyte solution was filled between the electrochromic layer and a charge retention layer, then cured and bonded by ultraviolet irradiation to prepare an electrochromic element.

### Formation of Protective Layer

On a side surface of the adhered insulating inorganic particle layer and second electrode layer, an ultraviolet curing adhesive (KAYARAD R-604, manufactured by Nippon Kayaku Co., Ltd.) was dropped and cured by ultraviolet light irradiation to form a protective layer having an average thickness of 3 μm.

From above, two electrochromic elements before thermoforming were produced.

### Production of Color Vision Correction Device

### Bending Process of Electrochromic Element

A bending process of pressurizing for 90 seconds at mold temperature of 145° C. with curvature radius of 130 mm was performed.

### Thickening of Electrochromic Element

A convex surface side of the bent electrochromic element was set to the center of a concave mold for injection molding, then a convex mold forming a pair with the concave mold was overlapped with the concave mold to be set in an injection molding machine as the mold having a curved surface of a curvature radius of 90 mm. A polycarbonate resin was injection molded to the electrochromic element in the mold by the injection molding machine and the two electrochromic elements were thickened.

### Outer Shape Process of Electrochromic Element

The two thickened electrochromic elements were processed into a lens shape so as to be accommodated in a rim shape in a frame of color vision correction spectacles, and projections having a width of 3 mm and a length of 5 mm were formed on both sides in a major axis direction of the electrochromic element.

### Formation of Electrode Pad in Electrochromic Element

A silver paste (Dotite, manufactured by FUJIKURA KASEI CO.,LTD.) as a conductive adhesive was applied to each of the projections in the two electrochromic elements with a brush or a toothpick, this was wrapped with copper foil to be cured for 15 minutes at 60° C. to electrically connect an end of the first electrode layer or the second electrode layer exposed by grinding the protective layer by the lens shaping process and the copper foil with the silver paste to form an electrode pad.

### Production of Color Vision Correction Spectacles

Next, the electrochromic elements were mounted on the rim of the frame equipped with a first light amount measuring device, a second light amount measuring device, a switch, a power source, and a control device to electrically connect the electrode pad to a connecting member arranged on the frame, and consequently, producing the color vision correction spectacles 100 as the color vision correction device.

### Color Developing Drive

The color development of the electrochromic element as the manufactured color vision correction device was confirmed. That is, a voltage was applied between the first electrode and the second electrode, and a change in transmittance was measured at the same time (FIG. 10). FIG. 10 is a graph of a measurement result. At 0 V, it was a transparent color erasing state, but as the voltage was increased, the transmittance decreased around 545 nm, and a color developing state was obtained.

### A Production of Light-Shielding Spectacles

Next, the electrochromic elements were mounted on the rim of the frame equipped with a first light amount measuring device, a second light amount measuring device, a switch, a power source, and a control device to electrically connect the electrode pad to a connecting member arranged on the frame, and consequently producing light-shielding spectacles as a medical light-shielding device. As the electrochromic material, a radical polymerizable compound including triarylamine expressed by the following General Formula 2 disclosed in paragraph 0096 of JP-2019-164249-A was used.

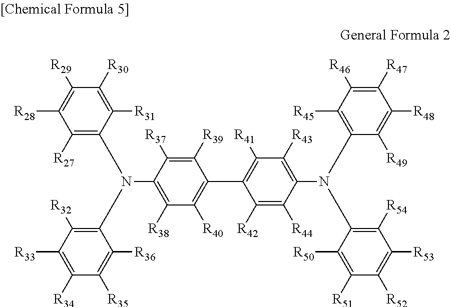

However, in General Formula 1 described above, R₂₇ to R₈₉ are all monovalent organic groups and may be the same or different; and at least one of the monovalent organic groups is a radical polymerizable functional group.

### Color Developing Drive

The color development of the electrochromic element as the produced medical light-shielding device was confirmed. That is, a voltage was applied between the first electrode and the second electrode, and a change in transmittance was measured at the same time. Table 1 illustrates measurement results. At 0 V, it was a transparent color erasing state, but as the voltage was increased, the transmittance decreased, and a color developing state was obtained.

TABLE 1

| | | |
|---|---|---|
| Wavelength [nm] | 505 | 555 |
| Color erasing time transmittance [%] | 75 | 75 |
| Color developing time transmittance [%] | 8 | 30 |

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An optical element using an electrochromic material capable of switching between a transparent state and a coloring state, the optical element comprising:
a spectrum assisting visual functions or visual perception ability,
wherein the spectrum is used for visual recognition of the optical element in the coloring state.

2. The optical element according to claim 1,
wherein the spectrum is able to assist color vision out of the visual functions.

3. The optical element according to claim 2,
wherein the spectrum is provided with a color vision correction spectrum characteristic curve used for converting a stimulation value proportion of three types of visual cone cells of a retina of a color-blind person.

4. The optical element according to claim 1,
wherein the spectrum is able to reduce photophobia out of the visual functions.

5. The optical element according to claim 1,
wherein the spectrum is for Irlen syndrome.

6. The optical element according to claim 1,
wherein a visual transmittance defined as a weighted light adaptation transmittance of a CIE standard illuminant D65 by a CIE 1932 2° standard observer of the optical element in a transparent state of the electrochromic material is higher than 70%.

7. The optical element according to claim 1,
wherein, in the coloring state, a gradient of coloring density is present in a plane of the optical element.

8. The optical element according to claim 1, further comprising circuitry configured to electrically controlling the transparent state and the coloring state of the electrochromic material.

9. The optical element according to claim 8,
wherein the circuitry is configured to receive an instruction of density from an input device via wired communication or wireless communication and adjust the density based on the received instruction.

10. The optical element according to claim 8, further comprising: a memory that stores information on density, wherein the circuitry controls the density in the coloring state using the information on the density.

11. The optical element according to claim 8,
wherein the circuitry controls density in the coloring state based on density information stored in an external memory connected via wired communication or wireless communication.

12. The optical element according to claim 8,
wherein the circuitry controls density in the coloring state based on a result detected by an ambient light detector.

13. The optical element according to claim 8,
wherein the circuitry measures a battery level of a power source connected to the circuitry, warns a user when the battery level is low, and automatically adjusts density to a color erasing state.

14. Spectacles comprising: two lens portions,
wherein the optical element according to claim 1 is incorporated in each lens portion.

15. The spectacles according to claim 14, further comprising: circuitry configured to independently control each optical element.
